(19) United States
(12) Patent Application Publication
(10) Pub. No.: US 2026/0039202 A1
(43) Pub. Date: Feb. 5, 2026

(54) DYNAMIC VOLTAGE SCALING FOR VOLTAGE CONVERTERS

(71) Applicant: TEXAS INSTRUMENTS INCORPORATED, Dallas, TX (US)

(72) Inventors: Somnath Samanta, Bangalore (IN); Udita Mukherjee, Bangalore (IN); Harshal Chapade, Bangalore (IN)

(21) Appl. No.: 19/282,967

(22) Filed: Jul. 28, 2025

(30) Foreign Application Priority Data
Aug. 2, 2024 (IN) 202441058890

(51) Int. Cl. H02M 3/158; H02M 1/00; H02M 1/08

(52) U.S. Cl. CPC H02M 3/1582; H02M 1/0009; H02M 1/0016; H02M 1/0025; H02M 1/08

(57) ABSTRACT

Described embodiments include an electronic circuit having input and output voltage terminals and an amplifier, a switch coupled between the amplifier output and a voltage-to-current converter input. A first comparator has inputs coupled to the input voltage terminal and a current sense terminal. A gate drive circuit has an input coupled to the first comparator output, and outputs controlling a high-side transistor and a low-side transistor. A current sense circuit input is coupled to the current sense terminal. A current regulation circuit has an input coupled to the current sense circuit and an output coupled to the V2I circuit. A second comparator has an input coupled to the amplifier input. A discharge circuit has an input coupled to the output of the second comparator, and an output coupled to the output voltage terminal. A feedforward circuit has an output coupled to the first comparator.

### CROSS-REFERENCE TO RELATED APPLICATION

This application claims priority to India patent application No. 202441058890 filed Aug. 2, 2024, which is incorporated herein by reference in its entirety.

### TECHNICAL FIELD

The present disclosure relates generally to an electronic system and method, and, in particular embodiments, to dynamic voltage scaling for voltage converters.

### BACKGROUND

Dynamic voltage scaling (DVS) may be understood as a technique for adjusting the supply voltage to a component or circuit, e.g., to manage power consumption and heat dissipation. For example, DVS may be used to change the supply voltage provided to a computer processor to save power when the processing load is smaller and to increase power when higher power is needed by the processor. DVS can also be used in a display system to adjust the brightness of the display by changing the magnitude of the voltage supplying the display.

### SUMMARY

In accordance to an embodiment, an electronic circuit including: an input voltage terminal; an output voltage terminal; an amplifier having an input and an output; a switch having first and second terminals, the first terminal of the switch coupled to the output of the amplifier; a voltage-to-current (V2I) circuit having an input and an output, the input of the V2I circuit coupled to the second terminal of the switch; a first comparator having first and second inputs and an output, the first input of the first comparator coupled to the input voltage terminal, the second input of the first comparator coupled to a current sense terminal that is configurable to provide a voltage proportional to an inductor current; a gate drive circuit having an input, and first and second outputs, the input of the gate drive circuit coupled to the output of the first comparator, the first and second outputs of the gate drive circuit configurable to provide control signals, respectively, to a high-side transistor and a low-side transistor; a current sense circuit having an input and first and second outputs, the input of the current sense circuit coupled to the current sense terminal; a current regulation circuit having an input and an output, the input of the current regulation circuit coupled to the first output of the current sense circuit, the output of the current regulation circuit coupled to the input of the V2I circuit; a second comparator having an input and an output, the input of the second comparator coupled to the input of the amplifier; a discharge circuit having an input and an output, the input of the discharge circuit coupled to the output of the second comparator, the output of the discharge circuit coupled to the output voltage terminal; and a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the first input of the first comparator.

In accordance to an embodiment, an electronic circuit including: an input voltage terminal; an output voltage terminal; a first amplifier having an input and an output, the input of the first amplifier configurable to receive a command voltage; a second amplifier having first and second inputs and an output, the first input of the second amplifier coupled to the output of the first amplifier, the second input of the second amplifier coupled to a ground terminal; a first resistor and a first switch coupled in parallel between the first and second inputs of the second amplifier; a second switch having first and second terminals, the first terminal of the second switch coupled to the output of the second amplifier; a comparator having first and second inputs and an output, the first input of the comparator coupled to the first input of the second amplifier, the second input of the comparator coupled to a reference voltage source; a third switch and a second resistor coupled in parallel between the second terminal of the second switch and the output of the comparator; and a discharge circuit having an input and an output, the input of the discharge circuit coupled to the output of the comparator, the output of the discharge circuit coupled to the output voltage terminal.

In accordance to an embodiment, a system, including: an input voltage terminal; an output voltage terminal; a digital-to-analog converter (DAC) having an input and an output, the input of the DAC configurable to receive a command voltage; an amplifier having an input and an output, the input of the amplifier coupled to the output of the DAC; a switch having first and second terminals, the first terminal of the switch coupled to the output of the amplifier; a voltage-to-current (V2I) circuit having an input and an output, the input of the V2I circuit coupled to the second terminal of the switch; a first comparator having first and second inputs and an output, the first input of the first comparator coupled to an input voltage terminal, the second input of the first comparator coupled to a current sense terminal that is configurable to provide a voltage proportional to an inductor current; a gate drive circuit having an input and first and second outputs, the input of the gate drive circuit coupled to the output of the first comparator, the first and second outputs of the gate drive circuit configurable to provide control signals, respectively, to a high-side transistor and a low-side transistor; a current sense circuit having an input and first and second outputs, the input of the current sense circuit coupled to the current sense terminal; a current regulation circuit having an input and an output, the input of the current regulation circuit coupled to the first output of the current sense circuit, the output of the current regulation circuit coupled to the input of the V2I circuit; a second comparator having an input and an output, the input of the second comparator coupled to the input of the amplifier; a discharge circuit having an input and an output, the input of the discharge circuit coupled to the output of the second comparator, the output of the discharge circuit coupled to an output voltage terminal; and a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the output of the V2I circuit.

### BRIEF DESCRIPTION OF THE DRAWINGS

For a more complete understanding of the present disclosure, and the advantages thereof, reference is now made to the following descriptions taken in conjunction with the accompanying drawings, in which:

FIGS. 1A and 1B show a schematic diagram for an example voltage regulator with an up DVS circuit, according to an embodiment of the present disclosure;

FIG. 2 shows a truth table for the control of switches in an example voltage regulator with an up DVS circuit, according to an embodiment of the present disclosure;

FIG. 3 shows a schematic diagram for an example feedforward circuit, according to an embodiment of the present disclosure;

FIG. 4 shows a timing diagram for an example voltage regulator with an up DVS circuit, according to an embodiment of the present disclosure; and

FIGS. 5A and 5B show a schematic diagram for an example two-phase voltage regulator with an up DVS circuit, according to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer to exactly the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Some embodiments relate to inverting voltage converters such as a voltage converter used to power a display driver. The inverting voltage converter may be included in a power management integrated circuit (PMIC).

Some embodiments relate to a voltage converter providing a negative voltage supply in which an input voltage from a battery or another type of supply input is regulated to provide a negative voltage output.

DVS can be used in a display system to adjust the display brightness by either increasing or decreasing the voltage supplying the display. For example, a higher supply voltage provided to a display may increase the brightness of the display and a lower supply voltage provided to a display may decrease the brightness of the display. Increasing the supply voltage from a first voltage level to a more positive or less negative voltage may be referred to as up DVS, and decreasing the supply voltage from a first voltage to a less positive or more negative voltage may be referred to as down DVS. Some embodiments relate to up DVS.

A display driver usually has a positive voltage supply and a negative voltage supply. Some embodiments relate to supplying the negative supply voltage to a display driver. In some embodiments, an inverting buck-boost voltage regulator that receives a positive voltage battery or supply input and converts it to a negative voltage output is used to supply the negative supply voltage. The voltage regulator and DVS circuitry may be included in a power management integrated circuit (PMIC).

For example, to increase the brightness of a display, the supply voltage provided to the display may be increased from −9V to −3V using up DVS. A system processor may request this change in supply voltage and provide a voltage command to the PMIC. The system may have a particular slew rate requirement for the rate of change in the supply voltage. If the change in the supply voltage provided to the display changes too quickly or too slowly, the resulting change in display brightness may be visually unpleasant.

In some systems, the slew rate requirement may be difficult to meet due to the limited bandwidth of the voltage converter. When the load current is small, the frequency of operation of the converter may be reduced to improve efficiency. Reducing the frequency of operation may reduce the bandwidth of the converter. In an example system, the bandwidth can be as low as 1 KHz at low load currents, producing a 1 msec delay in response to a command to change the output voltage. A slew rate requirement of 20 mV/μs, for example, may not be met if the system has a 1 msec delay.

Some embodiments are capable of providing an acceptable (e.g., not resulting in visually unpleasant artifact) slew rate in light load conditions.

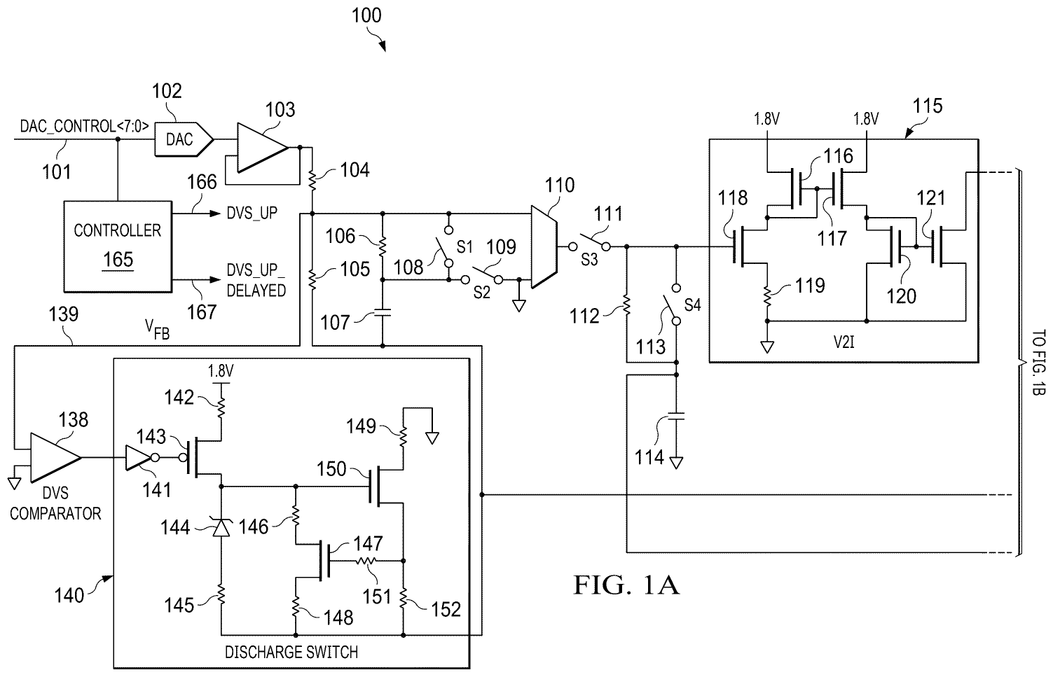

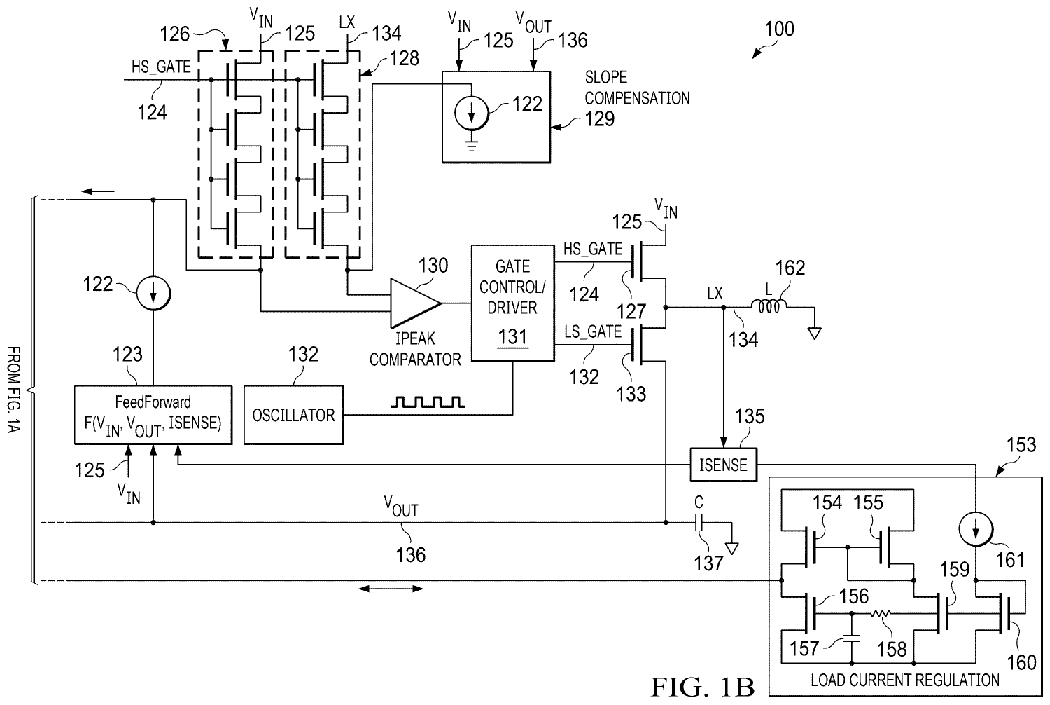

FIGS. 1A and 1B show a schematic diagram of voltage regulator 100 with an up DVS circuit, according to an embodiment of the present disclosure.

During normal operation, digital-to-analog converter (DAC) 102 receives an (e.g., 8-bit) digital voltage command DAC_Control 101 and produces a corresponding analog signal. The voltage command DAC_Control 101, which may be provided by a system processor (not shown), corresponds to the desired output voltage of the voltage converter. The output of DAC 102 is coupled to a first input of amplifier 103. A second input of amplifier 103 is coupled to the output of amplifier 103, which may configure amplifier 103 to have unity gain.

Resistor 104 has a first terminal coupled to the output of amplifier 103 and a second terminal coupled to a first input of amplifier 110. Resistor 105 is coupled between the second terminal of resistor 104 and an output voltage terminal V_{OUT} 136. Resistor 104 and resistor 105 form a voltage divider of the voltage at the output voltage terminal V_{OUT} 136. The terminal where resistor 104 is coupled to resistor 105 is a feedback voltage terminal VER 139 that provides a voltage proportional to the voltage at the output voltage terminal V_{OUT} 136.

Resistor 106 has a first terminal coupled to the feedback voltage terminal V_{FB} 139 and to a first input of amplifier 110. Capacitor 107 is coupled between a second terminal of resistor 106 and the output voltage terminal V_{OUT} 136. Switch S1 108 has a first terminal coupled to the first terminal of resistor 106 and a second terminal coupled to the second terminal of resistor 106. Switch S2 109 is coupled between the second terminal of switch S1 108 and the second input of amplifier 110. The second input of amplifier 110 is coupled to a ground terminal.

The output of amplifier 110 is coupled to a first terminal of switch S3 111. A second terminal of switch S3 111 is coupled to the input of voltage-to-current converter (V2I) circuit 115. Resistor 112 is coupled between the second terminal of switch S3 111 and a first terminal of capacitor 114. A second terminal of capacitor 114 is coupled to the ground terminal. Switch S4 113 is coupled in parallel with resistor 112.

V2I circuit 115 includes transistors 116, 117, 118, 120 and 121, and resistor 119. Transistor 118 is coupled between the drain of transistor 116 and a first terminal of resistor 119. A second terminal of resistor 119 is coupled to the ground terminal. The gate of transistor 118 is coupled to the second terminal of switch S3 111. Transistors 116 and 117 form a first current mirror with each of their sources coupled to a 1.8V voltage source, and their gates connected together and connected to the drain of transistor 116. Transistors 120 and 121 form a second current mirror with each of their gates connected together and connected to the drain of transistor 120. The sources of transistors 120 and 121 are each coupled to the ground terminal. The drain of transistor 120 is coupled to the drain of transistor 117. The drain of transistor 121 is coupled to a first input of comparator 130.

Transistor 126 is coupled between an input voltage terminal VIN 125 that provides an input voltage VIN and the first input of comparator 130. In some examples, transistor 126 may comprise multiple transistors connected in series. The gate of transistor 126 is coupled to a first output HS_GATE 124 of gate driver circuit 131, which provides a gate control signal for high-side FET 127. So, transistor 126 is turned on and conducts current only when high-side FET 127 is turned on.

Transistor 128 is coupled between the switching terminal LX 134 and the second input of comparator 130. In some examples, transistor 128 may comprise multiple transistors connected in series. The gate of transistor 128 is coupled to the first output HS_GATE 124 of gate driver circuit 131 that provides the gate control signal for high-side FET 127. So, transistor 128 is turned on and conducts current only when high-side FET 127 is turned on. The output of comparator 130 is coupled to the input of gate driver circuit 131. Gate driver circuit 131 has a first output HS_GATE 124 coupled to the gate of high-side FET 127 and a second output LS_GATE 132 coupled to the gate of low-side FET 133.

High-side FET 127 is coupled between the input voltage terminal VIN 125 and the switching terminal LX 134. Low-side FET 133 is coupled between the switching terminal LX 134 and the output voltage terminal V_{OUT} 136. Capacitor 137 is coupled between the output voltage terminal V_{OUT} 136 and the ground terminal. Inductor 162 is coupled between the switching terminal LX 134 and the ground terminal. Comparator 138 has a first input coupled to the feedback voltage terminal V_{FB} 139 and a second input coupled to the ground terminal.

Discharge switch circuit 140 includes inverter 141, Zener diode 144, resistors 142, 145, 146, 148, 149, 151 and 152, and transistors 143, 147 and 150. The input of inverter 141 is coupled to the output of comparator 138. Resistor 142 is coupled between the 1.8V voltage source and the source of transistor 143. The gate of transistor 143 is coupled to the output of inverter 141. The drain of transistor 143 is coupled to the cathode of Zener diode 144. Resistor 145 is coupled between the anode of Zener diode 144 and the output voltage terminal V_{OUT} 136.

Resistor 146 has a first terminal coupled to the drain of transistor 143 and a second terminal coupled to the source of transistor 147. Resistor 148 is coupled between the drain of transistor 147 and the output voltage terminal V_{OUT} 136. Resistor 149 is coupled between the ground terminal and the drain of transistor 150. The gate of transistor 150 is coupled to the drain of transistor 143. Resistor 151 is coupled between the gate of transistor 147 and the source of transistor 150. Resistor 152 is coupled between the source of transistor 150 and the output voltage terminal V_{OUT} 136.

Load current regulation circuit 153 includes transistors 154, 155, 156, 159 and 160, capacitor 157, resistor 158, and current source 161. Transistors 154 and 155 form a current mirror with their respective gates connected together and their respective sources connected together and connected to the 1.8V voltage source. The drain of transistor 155 is coupled to the gates of transistors 154 and 155. The drain of transistor 154 is coupled to the first terminal of capacitor 114. Transistor 156 is coupled between the drain of transistor 154 and the ground terminal.

Capacitor 157 is coupled between the gate of transistor 156 and the ground terminal. Resistor 158 is coupled between the gate of transistor 156 and gate of transistor 159. Transistors 159 and 160 form a current mirror with their respective gates connected together and their respective sources connected together. The sources of transistors 159 and 160 are coupled to the ground terminal. The drain of transistor 159 is coupled to the drain of transistor 155. The drain of transistor 160 is coupled to the output of current source 161. Oscillator 132 is coupled to and provides a clock signal to gate driver circuit 131. The frequency of this clock signal determines the switching frequency of voltage regulator 100.

ISENSE circuit 135 has an input coupled to the switching terminal LX 134. ISENSE circuit 135 has a first output coupled to a first input of feedforward circuit 123, and a second output coupled to the input of current source 161. ISENSE circuit 135 senses the average current flowing through inductor 162 during the time when LS_GATE 132 is turned on. So, ISENSE circuit 135 senses the average load current provided to the output voltage terminal V_{OUT} 136 and provides that current at its output.

Feedforward circuit 123 has a first input coupled to the input voltage terminal VIN 125, a second input coupled to the output voltage terminal V_{OUT} 136, and a third input coupled to the first output of ISENSE circuit 135. Feedforward circuit 123 has an output coupled to a first terminal of current source 122. A second terminal of current source 122 is coupled to the first input of comparator 130. The values for the input voltage, output voltage, and sensed current are used by feedforward circuit 123 to calculate the peak current at the output voltage terminal V_{OUT} 136.

In some embodiments, controller 165 may be implemented as a generic or custom processor or controller coupled to a memory and configured to execute instructions in such memory. In some embodiments, controller 165 may be implemented using a field programmable gate array (FPGA). In some embodiments, controller 165 includes combinational logic, sequential logic, programmable logic (e.g., in combination with program memory), or the like, or a combination thereof. In some embodiments, controller 165 includes a state machine. In some embodiments, controller 165 includes a hardware accelerator. In some embodiments, controller 165 is implemented using synthesized logic. Other implementations may also possible.

In some embodiments, feedforward circuit 123 helps to improve the line transient response of voltage regulator 100 by providing faster feedback when the voltage at the input voltage terminal VIN 125 changes. Feedforward circuit 123 may also help to avoid the delay due to the pole generated by capacitor 114. When the voltage at input voltage terminal VIN 125 changes, much of the correction (e.g. 90-95%) can come through feedforward circuit 123 and come more quickly, improving the output transient response.

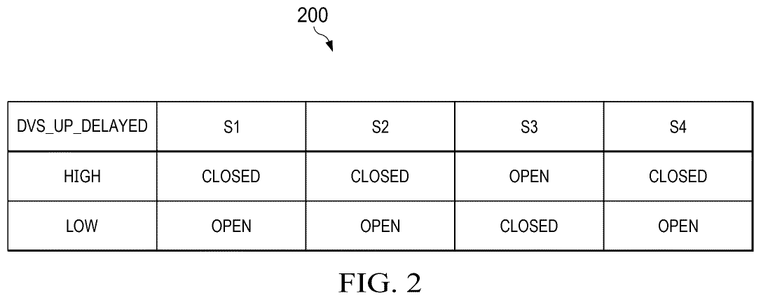

In some embodiments, controller 165 receives the signal DAC_Control 101 as an input. If an up DVS operation is indicated by a change in the commanded output voltage of voltage regulator 100, controller 165 provides signals DVS_UP 166 as a first output and DVS_UP_DELAYED 167 as a second output. DVS_UP 166 goes high when the up DVS operation is to begin and goes low when the up DVS operation is complete, then remains low otherwise. DVS_UP_DELAYED 167 may assert (e.g., transition to logic high) at the same time as DVS_UP 166 and may remain asserted until a particular delay time (e.g. 4 μs) after the falling edge of DVS_UP 166, then remains deasserted (e.g., logic low) otherwise. The signal DVS_UP_DELAYED 167 is provided to the respective control terminals of and controls opening and closing switches S1 108, S2 109, S3 111, and S4 113, e.g., in accordance with the table in FIG. 2.

DAC_Control 101 is a digital signal input to DAC 102 that provides the regulated output voltage command for voltage regulator 100. DAC 102 converts the signal DAC_Control 101 to an analog voltage. In some embodiments, amplifier 103 provides current drive from the DAC output with unity voltage gain.

In some embodiments, a resistor voltage divider formed by resistors 104 and 105 provides a feedback voltage proportional to the voltage at the output voltage terminal V_{OUT} 136. This feedback voltage is summed with the output of amplifier 103, which provides a subtraction of the commanded output voltage from the measured output voltage.

A pole-zero formed by capacitor 107 and resistors 105 and 106 may provide filtering of the signal at the output of amplifier 103 prior to being provided to the first input of amplifier 110. The second input of amplifier 110 is coupled to the ground terminal so that the voltage difference between the commanded output voltage and the actual output voltage is referenced to ground in amplifier 110. Resistor 112 and capacitor 114 together with capacitor 107 and resistor 105 provide compensation of the overall voltage converter loop.

In some embodiments, V2I circuit 115 receives a voltage from the output of amplifier 110 and converts it to a sink current that flows from the output of V2I circuit 115. The output of amplifier 110 is coupled to the gate of transistor 118. Resistor 119 is coupled between transistor 118 and the ground terminal. The magnitude of the current at the output of V2I circuit 115 is the difference between the output voltage of amplifier 110 and the threshold voltage of transistor 118 divided by the resistance of resistor 119. That current is mirrored in the current mirror formed by transistors 116 and 117, then mirrored back again using the current mirror formed by transistors 120 and 121 to produce a sink current.

Comparator 130 has an input coupled to the switching terminal LX 134 which provides a voltage to comparator 130 when the high-side FET 127 is turned on and charging inductor 162. The other input of comparator 130 is coupled to the output of V2I circuit 115 providing the reference peak current that the current through inductor 162 is compared to. When the output of comparator 130 toggles indicating the inductor peak current has reached the reference current level, high-side FET 127 turns off and low-side FET 133 turns on. The voltage at the switching terminal LX 134 is equal to the voltage at the input voltage terminal VIN 125 minus the inductor current multiplied by the on-resistance of high-side FET 127.

In some embodiments, the voltage at the other input of comparator 130 is equal to the voltage at the input voltage terminal VIN 125 minus the on-resistance of transistor 126 multiplied by the sum of the current at the output of V2I circuit 115 and the current from feedforward circuit 123. Comparator 130 toggles when the sum of the current at the output of V2I circuit 115 and the current from feedforward circuit 123 multiplied by the on-resistance of transistor 126 equals the current through inductor 162 multiplied by the on-resistance of high-side FET 127. This controls the peak current because a change in current at the output of V2I circuit 115 results in a proportional change in the current through inductor 162.

In some embodiments, when the duty cycle is higher than 50%, the inductor current waveform may bifurcate producing a pattern that resembles an undesirable oscillation. To avoid this current bifurcation, slope compensation circuit 129 adds a compensating current at the input of comparator 130. Slope compensation circuit 129 has a first input coupled to the input voltage terminal VIN 125 and a second input coupled to the output voltage terminal V_{OUT} 136. The output of slope compensation circuit 129 provides the compensation current.

The sensed current from the output of ISENSE circuit 135 is provided to current source 161 in load current regulation circuit 153. The current from current source 161 is provided to the current mirror formed by transistors 159 and 160. The mirrored current from transistor 159 is provided to an R-C filter formed by resistor 158 and capacitor 157. The filtered version of the mirrored current is provided to the gate of transistor 156.

The mirrored current from transistor 159 is provided unfiltered to the current mirror formed by transistors 154 and 155 and is indicative of the present load current. The R-C filter formed by resistor 158 and capacitor 157 produces a delay (e.g. 100 μs) and is indicative of the load current prior to the delay time. Comparing the present load current to the current prior to the delay gives an indication of whether the load current is increasing, decreasing, or remaining the same.

The mirrored current from transistor 159 and the filtered mirrored current from transistor 156, which have opposite polarities, are summed together at the output of load current regulation circuit 153. If the load current is not changing, the unfiltered mirrored current and the filtered mirrored current may be equal and may cancel out, so the output of load current regulation circuit 153 may be zero. If the filtered load current is higher than the unfiltered load current, the load current is decreasing and the current output of load current regulation circuit 153 may decrease. If the filtered load current is lower than the unfiltered load current, the load current is increasing and the current output of the load current regulation circuit may increase. The current output of load current regulation circuit 153 can sink current, source current, or provide zero current depending on if and how the load current is changing.

When the load current is relatively small, the frequency of oscillator 132 may be reduced to improve efficiency of voltage regulator 100. Reducing the output frequency of oscillator 132 can reduce the closed-loop bandwidth of voltage regulator 100, which may lead to failing to meet the slew rate specification for the output voltage during an up DVS operation. In such situations, some embodiments improve the transient response by opening the voltage control loop during an up DVS operation to alleviate the voltage control loop bandwidth restriction. In some embodiments, the voltage control loop can be opened by opening switch S3 111. The voltage control loop can then be closed again following the up DVS operation by closing switch S3 111.

When operating with the voltage control loop open, voltage regulator 100 continues to switch and provide load current at the output voltage terminal V_{OUT} 136, but amplifier 110 is no longer providing output voltage regulation because it has been removed from the circuit path. In some embodiments, the load current continues to be regulated to avoid either an excessive overshoot or an excessive undershoot when the voltage loop gets reclosed following the end of a DVS operation.

In some embodiments, during an up DVS operation when the voltage control loop is opened by opening switch S3 111, voltage control is accomplished through comparator 138 and discharge switch circuit 140. A first input of comparator 138 is coupled to the first input of amplifier 110 and receives a voltage equal to the voltage difference between the commanded output voltage and the output voltage feedback. A second input of comparator 138 is coupled to ground which acts as a reference voltage for comparator 138. The output of comparator 138 is coupled to the input of discharge switch circuit 140.

Switches S1 108, S2 109. S3 111, and S4 113 are each controlled by the signal DVS_UP_DELAYED 167 provided by controller 165 according to the table shown in FIG. 2.

In some embodiments, an up DVS operation begins with signals DVS_UP 166 and DVS_UP_DELAYED 167 going high and continues until DVS_UP 166 goes low again. DVS_UP_DELAYED 167 then goes low a set delay time following DVS_UP 166 going low. When DVS_UP_DELAYED 167 goes high, switch S3 111 opens and switches S1 108, S2 109, and S4 113 each close. When DVS_UP_DELAYED 167 goes low again, switch S3 111 closes and switches S1 108, S2 109, and S4 113 each open.

In some embodiments, during an up DVS operation, capacitor 137 is discharged to make the voltage at output voltage terminal V_{OUT} 136 more positive. Capacitor 137 is discharged by current flowing from the output voltage terminal V_{OUT} 136 to ground through discharge switch circuit 140. A 1.8 V supply voltage powers inverter 141 and transistor 143 in discharge switch circuit 140 and comparator 138. When comparator 138 toggles, transistor 143 is turned on allowing current to flow through transistor 143. Zener diode 144 and resistor 145. Zener diode 144 and resistor 145 form a 6V clamp to protect the gate of transistor 150 from breaking down.

When transistor 143 is turned on, current flows through it to the gate of transistor 150, turning it on. Turning transistor 150 on sinks current from the output voltage terminal V_{OUT} 136 to ground. The current flow produces a voltage across resistor 152, which limits the current. Transistor 147 provides negative feedback working with Zener diode 144 and resistor 145 to protect the circuit.

An inverting buck boost voltage converter may only deliver power to the output voltage terminal V_{OUT} 136 during the time when high-side FET 127 is turned off or in the second half of each switching cycle. During the time when high-side FET 127 is turned on or in the first half of the switching cycle, inductor 162 is charged through current flowing to ground, then current is dumped from ground into the output voltage terminal V_{OUT} 136 in the second half of the switching cycle, making the output voltage negative. The peak load current can be calculated from the input voltage, output voltage and load current using feedforward circuit 123. The output of feedforward circuit 123 is provided to current source 122 allowing the circuitry downstream from it to provide voltage regulation when the voltage control loop is opened by opening switch S3 111. Not all non-idealities can be compensated for completely, but voltage regulation may be improved when switch S3 111 is closed.

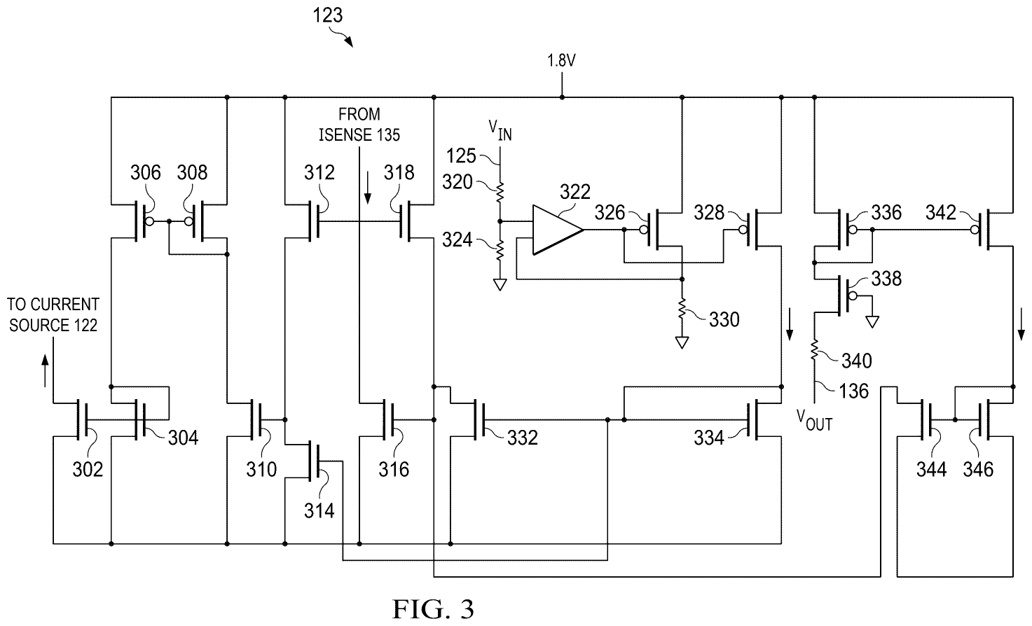

FIG. 3 shows a schematic diagram of feedforward circuit 123, according to an embodiment of the present disclosure. Resistor 340 has a first terminal coupled to the output voltage terminal V_{OUT} 136. Transistor 338 is a native transistor and is coupled between the second terminal of resistor 340 and the drain of transistor 336. The gate of transistor 338 is coupled to the ground terminal. Transistors 336 and 342 form a current mirror and have their respective gates connected together. The sources of transistors 336 and 342 are each coupled to the 1.8V voltage source.

Resistor 320 is coupled between the input voltage terminal VIN 125 and the first terminal of amplifier 322. Resistor 324 is coupled between the first terminal of amplifier 322 and the ground terminal. Transistor 326 is coupled between the 1.8V voltage source and the second input of amplifier 322. Resistor 330 is coupled between the second input of amplifier 322 and the ground terminal. Transistors 326 and 328 form a current mirror and have their respective gates connected together. The source of transistor 328 is coupled to the source of transistor 326 and to the 1.8V voltage source.

Transistors 334 and 332 form a current mirror and have their respective gates connected together and their respective sources connected together. The drain of transistor 334 is connected to the gates of transistor 334 and 332. Transistor 318 is coupled between the 1.8V voltage source and the drain of transistor 344. Transistor 316 is coupled between the output of the ISENSE circuit 135 and the source of transistor 332 and has a gate coupled to the drain of transistor 318.

Transistor 312 has a source coupled to the 1.8V voltage source and a gate coupled to the gate of transistor 318. Transistor 314 is coupled between the drain of transistor 312 and the source of transistor 332 and has a gate coupled to the gate of transistor 332. Transistors 306 and 308 form a current mirror and have their gates connected together and each of their sources are connected to the 1.8V voltage source. The drain of transistor 308 is connected to the gates of transistors 308 and 306. Transistor 310 is coupled between the drain of transistor 308 and the source of transistor 334 and has a gate coupled to the drain of transistor 312.

Transistors 302 and 304 form a current mirror and have their gates connected together and each of their sources are connected to the source of transistor 334. The drain of transistor 304 is coupled to the drain of transistor 306 and to the gates of transistors 302 and 304. The drain of transistor 302 is coupled to current source 122 and provides the output current IFF of feedforward circuit 123. The current IFF provided by the feedforward circuit 123 is equal to:

$${I}_{FF} = K * ISENSE * ( {V}_{OUT} + {V}_{IN} ) / {V}_{IN}$$

where K is a scale factor, I_{SENSE} is the output current of the I_{SENSE} circuit 135, V_{OUT} is the voltage at the output voltage terminal V_{OUT} 136, and VIN is the voltage at the input voltage terminal VIN 125.

In some embodiments, feedforward circuit 123 receives V_{OUT}, V_{IN}, and I_{SENSE} as inputs and provides the current I_{FF} as an output to current source 122. V_{IN} is provided by the input voltage terminal V_{IN} 125 to a voltage divider formed by resistors 320 and 324. The first input of amplifier 322 is coupled to the center terminal of the voltage divider and receives a voltage proportional to V_{IN}. The output of amplifier 322 controls the current mirror formed by transistors 326 and 328 which provides a current to resistor 330 that is proportional to the voltage from the voltage divider. The current through resistor 330 is proportional to V_{IN} and is equal to the voltage from the voltage divider divided by the resistance of resistor 330. The current through resistor 330 is mirrored using the current mirror formed by transistors 326 and 328 to produce a V_{IN}-dependent current. That V_{IN}-dependent current is provided to the current mirror formed by transistors 332 and 334.

The voltage V_{OUT} is provided by the output voltage terminal V_{OUT} 136 to transistor 338, which is a native transistor. Because transistor 338 is a native device, its source may be at the same voltage as its gate. The current through transistor 338 is equal to V_{OUT} divided by the resistance of resistor 340, so a V_{OUT}-dependent current flows through transistor 338. This V_{OUT}-dependent current is mirrored using the current mirror formed by transistors 336 and 342 and mirrored again using the current mirror formed by transistors 344 and 346.

The V_{OUT}-dependent current and the V_{IN}-dependent current are added at transistor 318, so the current through transistor 318 is equal to V_{OUT}+V_{IN}. The sum of the V_{OUT}-dependent current and the V_{IN}-dependent current is logarithmically multiplied with I_{SENSE} in transistors 318 and 316. The V_{IN}-dependent current from the current mirror formed by transistors 332 and 334 is provided to the gate of transistor 314. The current at the gate of transistor 310 is equal to the current through transistor 312 minus the current through transistor 314. Because subtraction is logarithmic division, this difference produces a logarithmic version of a current equal to I_{SENSE}*(V_{OUT}+V_{IN})/V_{IN}. That current I_{FF} is mirrored by the current mirror formed by transistors 306 and 308, mirrored again by the current mirror formed by transistors 304 and 302, and provided at the output of feedforward circuit 123 to current source 122.

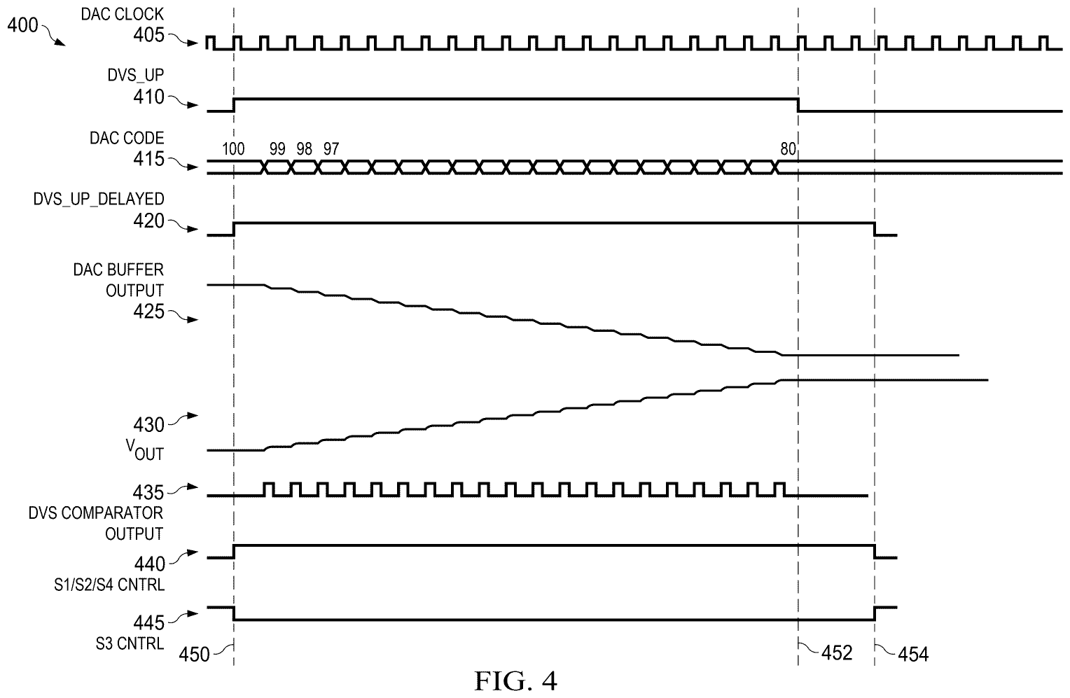

FIG. 4 shows timing diagram 400 of a voltage regulator with an up DVS circuit, such as voltage regulator 100, according to an embodiment of the present disclosure. Curve 405 shows a plot of voltage versus time for a DAC clock (not shown). With each successive rising edge of the DAC clock, a new value for DAC_CONTROL 101 is provided to DAC 102. Curve 410 shows a plot of voltage versus time for the signal DVS_UP 166 which is provided at a first output of controller 165. DVS_UP 166 goes high when an up DVS operation begins and remains high during the up DVS operation. DVS_UP 166 then goes low again when the up DVS operation is complete.

Curve 415 shows a plot of the DAC code DAC_CONTROL 101 versus time. On the rising edge of each DAC clock, a new value is loaded into DAC 102. Curve 420 shows a plot of voltage versus time for the signal DVS_UP_DELAYED 167 which is provided at a second output of controller 165. DVS_UP_DELAYED 167 goes high on the rising edge of DVS_UP 166 and remains high until a set delay time after DVS_UP 166 goes low. Curve 425 shows a plot of voltage versus time for the signal at the output of amplifier 103, which is an analog version of DAC_CONTROL 101.

Curve 430 shows a plot of voltage versus time for the signal at the output voltage terminal V_{OUT} 136. Curve 435 shows a plot of voltage versus time for the signal at the output of comparator 138. Curve 440 shows a plot of voltage versus time for the signal provided to the control terminal of switches S1 108, S2 109, and S4 113. Curve 445 shows a plot of voltage versus time for the signal provided to the control terminal of switch S3 111.

During an up DVS operation, the DAC code decreases in value. The frequency of the DAC clock is derived based on the chosen slew rate. As an example, for a 10 mV per microsecond slew rate and a step size of 40 mV, the DAC clock has a four microsecond period, and the DAC code changes every four microseconds. The slew rate can be increased or decreased by increasing or decreasing the DAC clock frequency. The DAC code changes one step for each DAC clock while it is slewing. For example, if an up DVS command is given to change from a DAC code of 100 to 80, the DAC code first changes from 100 to 99 on the rising edge of the next DAC clock, then change to 98 on the rising edge of the next clock. This pattern may continue with each subsequent DAC clock until the DAC code reaches 80.

The output of DAC 102 is an analog voltage that is provided to amplifier 103. The output of amplifier 103 decreases as the DAC code decreases. As the output of amplifier 103 decreases, the output of comparator 138 goes high causing discharge switch circuit 140 to sink current until the voltage at the output voltage terminal V_{OUT} 136 changes and the output of comparator 138 toggles back low. Every time the DAC code changes, comparator 138 toggles and current is dumped to ground through discharge switch circuit 140 causing the voltage at the output voltage terminal V_{OUT} 136 to increase until it reaches the final commanded voltage.

DVS_UP 166 goes high one DAC clock cycle before the DAC code starts decreasing from 100 to 99. DVS_UP 166 then goes back low one DAC clock cycle after the final code is reached. DVS_UP 166 being high indicates that the DAC codes are being changed and the period of time over which the DAC code transition is occurring. DVS_UP_DELAYED 167 is DVS_UP 166 with a delay on the falling edge. The delay allows for settling of the output voltage prior to reclosing the voltage control loop following an up DVS operation. DVS_UP_DELAYED 167 controls switches S1 108, S2 109, S3 111, and S4 113. The polarity is different for switch S3 111 which is open when DVS_UP_DELAYED is high while the other three switches are closed. DVS_UP_DELAYED 167 can also be used to enable and disable comparator 138 and discharge switch circuit 140 to save power because they are only needed during an up DVS operation.

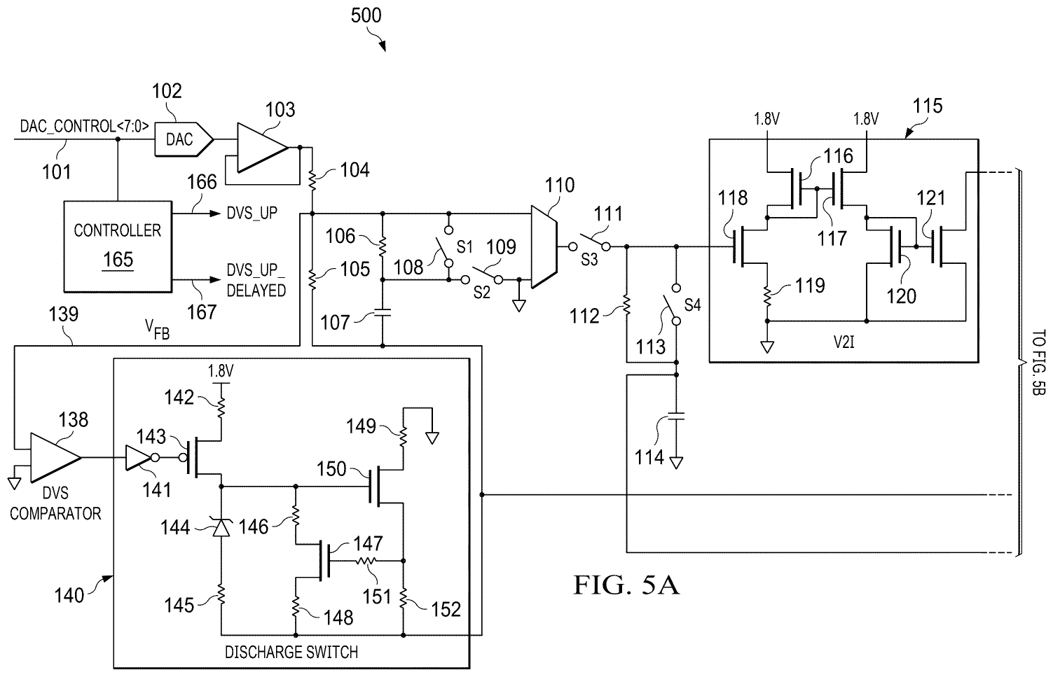

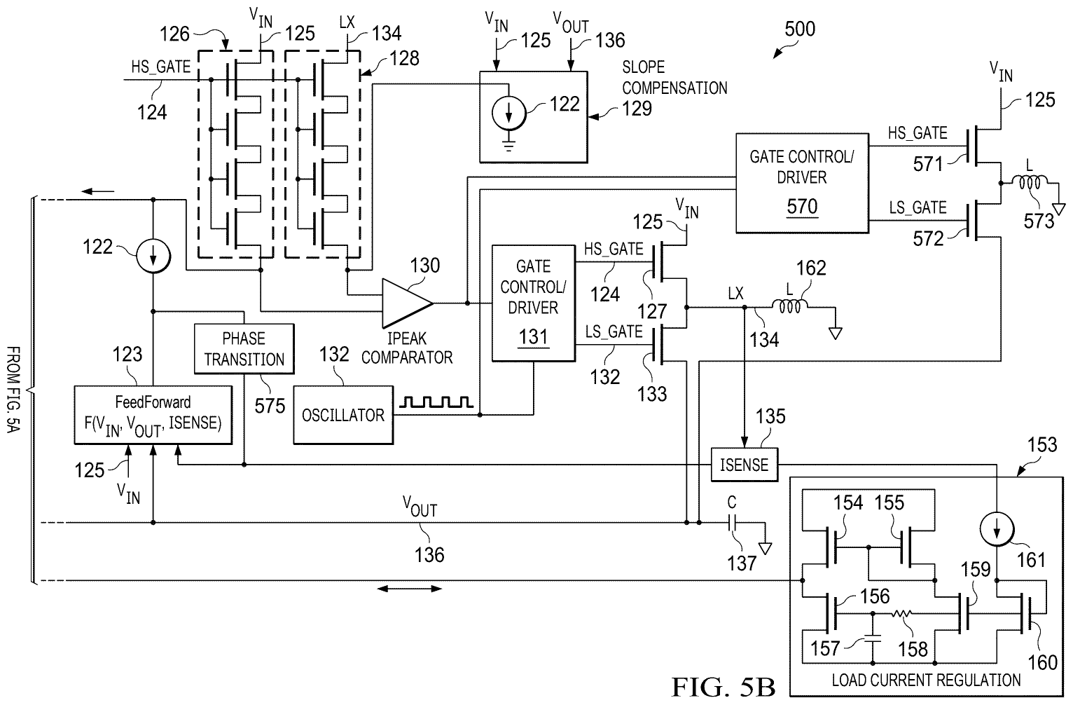

FIGS. 5A and 5B show a schematic diagram of two-phase voltage regulator 500 with an up DVS circuit. Voltage regulator 500 operates in a similar manner to voltage regulator 100 and may performed up DVS operation in a similar manner. Voltage regulator 500, however, is a two-phase converter in which two inductors are used to deliver power to the load in tandem. Thus, as shown in FIGS. 5A and 5B, voltage regulator 500 includes some additional components for the second phase.

The additional components in voltage regulator 500 include gate driver circuit 570, high-side FET 571, low-side FET 572, and inductor 573. Voltage regulator 500 also includes phase transition circuit 575 which determines if additional current is needed above what the first phase can provide and handles the transition from single-phase operation to two-phase operation. The phases and transitions from single-phase operation to two-phase operation of the voltage converter are controlled in a conventional manner.

Example embodiments of the present disclosure are summarized here. Other embodiments can also be understood from the entirety of the specification and the claims filed herein.

Example 1. An electronic circuit including: an input voltage terminal; an output voltage terminal; an amplifier having an input and an output; a switch having first and second terminals, the first terminal of the switch coupled to the output of the amplifier; a voltage-to-current (V2I) circuit having an input and an output, the input of the V2I circuit coupled to the second terminal of the switch; a first comparator having first and second inputs and an output, the first input of the first comparator coupled to the input voltage terminal, the second input of the first comparator coupled to a current sense terminal that is configurable to provide a voltage proportional to an inductor current; a gate drive circuit having an input, and first and second outputs, the input of the gate drive circuit coupled to the output of the first comparator, the first and second outputs of the gate drive circuit configurable to provide control signals, respectively, to a high-side transistor and a low-side transistor; a current sense circuit having an input and first and second outputs, the input of the current sense circuit coupled to the current sense terminal; a current regulation circuit having an input and an output, the input of the current regulation circuit coupled to the first output of the current sense circuit, the output of the current regulation circuit coupled to the input of the V2I circuit; a second comparator having an input and an output, the input of the second comparator coupled to the input of the amplifier; a discharge circuit having an input and an output, the input of the discharge circuit coupled to the output of the second comparator, the output of the discharge circuit coupled to the output voltage terminal; and a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the first input of the first comparator.

Example 2. The electronic circuit of example 1, where the discharge circuit includes: a first transistor having first and second terminals and a control terminal, the control terminal of the first transistor coupled to the output of the second comparator, and the first terminal of the first transistor coupled to a voltage terminal; a Zener diode coupled between the second terminal of the first transistor and the output voltage terminal; a second transistor having first and second terminals and a control terminal, the first terminal of the second transistor coupled to the second terminal of the first transistor, the second terminal of the second transistor coupled to the output voltage terminal; and a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

Example 3. The electronic circuit of one of examples 1 or 2, further including a compensation circuit coupled to the current sense terminal.

Example 4. The electronic circuit of one of examples 1 to 3, where the V2I circuit includes: a first transistor having first and second terminals and a control terminal, the first terminal of the first transistor coupled to the input voltage terminal; a second transistor having first and second terminals and a control terminal, the first terminal of the second transistor coupled to the input voltage terminal, and the control terminal of the second transistor coupled to the control terminal of the second transistor and the second terminal of the first transistor; a third transistor having first and second terminals and a control terminal, the first terminal of the third transistor coupled to the second terminal of the first transistor, the second terminal of the third transistor coupled to a ground terminal, and the control terminal of the third transistor coupled to the output of the amplifier; a fourth transistor having first and second terminals and a control terminal, the first terminal of the fourth transistor and the control terminal of the fourth transistor coupled to the second terminal of the second transistor, and the second terminal of the fourth transistor coupled to the ground terminal; and a fifth transistor having first and second terminals and a control terminal, the first terminal of the fifth transistor coupled to the first input of the first comparator, the second terminal of the fifth transistor coupled to the ground terminal, and the control terminal of the fifth transistor coupled to the control terminal of the fourth transistor.

Example 5. The electronic circuit of one of examples 1 to 4, where the first comparator is configurable to receive signals at its first and second inputs only when the high-side transistor is turned on.

Example 6. The electronic circuit of one of examples 1 to 5, where the current sense circuit includes first and second filters, the first filter of the current sense circuit having a higher bandwidth than the second filter of the current sense circuit.

Example 7. The electronic circuit of one of examples 1 to 6, further including: a digital-to-analog converter (DAC) having an output; a first resistor coupled between the output of the DAC and the input of the amplifier; and a second resistor coupled between the input of the amplifier and the output voltage terminal.

Example 8. The electronic circuit of one of examples 1 to 7, where the switch is a first switch, and the electronic circuit is further including a resistor and a second switch coupled in parallel between the output of the current regulation circuit and the input to the V2I circuit.

Example 9. The electronic circuit of one of examples 1 to 8, where the resistor is a first resistor, the input to the amplifier is a first input to the amplifier, the amplifier has a second input, and the electronic circuit is further including a second resistor and a third switch coupled in parallel between the first and second inputs of the amplifier.

Example 10. The electronic circuit of one of examples 1 to 9, where the input voltage terminal is configured to receive a positive voltage, and the output voltage terminal is configured to provide a negative voltage.

Example 11. The electronic circuit of one of examples 1 to 10, further including an inductor coupled to the current sense terminal.

Example 12. The electronic circuit of one of examples 1 to 11, where the inductor is a first inductor and the gate drive circuit is a first gate drive circuit, the electronic circuit further including a second inductor, a second gate drive circuit, and a phase transition circuit configurable to control phases and transitions from single-phase operation to two-phase operation.

Example 13. The electronic circuit of one of examples 1 to 12, where the feedforward circuit includes: a circuit configurable to provide a first current proportional to a voltage at the output voltage terminal; a circuit configurable to provide a second current proportional to a voltage at the input voltage terminal; a circuit configurable to provide a third current that is a sum of the first current and the second current; and a circuit configurable to provide a fourth current that is a product of the third current and a current provided at the second output of the current sense circuit.

Example 14. An electronic circuit including: an input voltage terminal; an output voltage terminal; a first amplifier having an input and an output, the input of the first amplifier configurable to receive a command voltage; a second amplifier having first and second inputs and an output, the first input of the second amplifier coupled to the output of the first amplifier, the second input of the second amplifier coupled to a ground terminal; a first resistor and a first switch coupled in parallel between the first and second inputs of the second amplifier; a second switch having first and second terminals, the first terminal of the second switch coupled to the output of the second amplifier; a comparator having first and second inputs and an output, the first input of the comparator coupled to the first input of the second amplifier, the second input of the comparator coupled to a reference voltage source; a third switch and a second resistor coupled in parallel between the second terminal of the second switch and the output of the comparator; and a discharge circuit having an input and an output, the input of the discharge circuit coupled to the output of the comparator, the output of the discharge circuit coupled to the output voltage terminal.

Example 15. The electronic circuit of example 14, further including: a third resistor having first and second terminals, the first terminal of the third resistor coupled to the output of the first amplifier; and a fourth resistor having first and second terminals, the first terminal of the fourth resistor coupled to the second terminal of the first resistor, the second terminal of the fourth resistor coupled to an output voltage terminal.

Example 16. The electronic circuit of one of examples 14 or 15, where the discharge circuit includes: a first transistor having first and second terminals and a control terminal, the control terminal of the first transistor coupled to the output of the comparator, and the first terminal of the first transistor coupled to a voltage terminal; a Zener diode coupled between the second terminal of the first transistor and the output voltage terminal; a second transistor having first and second terminals and a control terminal, the first terminal of the second transistor coupled to the second terminal of the first transistor, the second terminal of the second transistor coupled to the output voltage terminal; and a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

Example 17. The electronic circuit of one of examples 14 to 16, where the second switch is configured to open in response to a change in the command voltage.

Example 18. The electronic circuit of one of examples 14 to 17, where the third switch is configured to close in response to the second switch opening.

Example 19. The electronic circuit of one of examples 14 to 18, further including a current regulation circuit having an input and an output, the input of the current regulation circuit coupled to a current sense circuit, the output of the current regulation circuit coupled to the output of the comparator.

Example 20. A system, including: an input voltage terminal; an output voltage terminal; a digital-to-analog converter (DAC) having an input and an output, the input of the DAC configurable to receive a command voltage; an amplifier having an input and an output, the input of the amplifier coupled to the output of the DAC; a switch having first and second terminals, the first terminal of the switch coupled to the output of the amplifier; a voltage-to-current (V2I) circuit having an input and an output, the input of the V2I circuit coupled to the second terminal of the switch; a first comparator having first and second inputs and an output, the first input of the first comparator coupled to an input voltage terminal, the second input of the first comparator coupled to a current sense terminal that is configurable to provide a voltage proportional to an inductor current; a gate drive circuit having an input and first and second outputs, the input of the gate drive circuit coupled to the output of the first comparator, the first and second outputs of the gate drive circuit configurable to provide control signals, respectively, to a high-side transistor and a low-side transistor; a current sense circuit having an input and first and second outputs, the input of the current sense circuit coupled to the current sense terminal; a current regulation circuit having an input and an output, the input of the current regulation circuit coupled to the first output of the current sense circuit, the output of the current regulation circuit coupled to the input of the V2I circuit; a second comparator having an input and an output, the input of the second comparator coupled to the input of the amplifier; a discharge circuit having an input and an output, the input of the discharge circuit coupled to the output of the second comparator, the output of the discharge circuit coupled to an output voltage terminal; and a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the output of the V2I circuit.

Example 21. The system of example 20, where the switch is configured to open in response to a change in the command voltage.

Example 22. The system of one of examples 20 or 21, where the switch is a first switch, and the system is further including a second switch and a resistor coupled in parallel between the second terminal of the first switch and the output of the first comparator.

Example 23. The system of one of examples 20 to 22, where the second switch is configured to close in response to the first switch opening.

Example 24. The system of one of examples 20 to 23, where a change in the command voltage changes a brightness of a display.

Example 25. The system of one of examples 20 to 24, where the discharge circuit includes: a first transistor having first and second terminals and a control terminal, the control terminal of the first transistor coupled to the output of the second comparator, and the first terminal of the first transistor coupled to a voltage terminal; a Zener diode coupled between the second terminal of the first transistor and the output voltage terminal; a second transistor having first and second terminals and a control terminal, the first terminal of the second transistor coupled to the second terminal of the first transistor, the second terminal of the second transistor coupled to the output voltage terminal; and a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

Example 26. The system of one of examples 20 to 25, where the V2I circuit includes: a first transistor having first and second terminals and a control terminal, the first terminal of the first transistor coupled to the input voltage terminal; a second transistor having first and second terminals and a control terminal, the first terminal of the second transistor coupled to the input voltage terminal, and the control terminal of the second transistor coupled to the control terminal and the second terminal of the first transistor; a third transistor having first and second terminals and a control terminal, the first terminal of the third transistor coupled to the second terminal of the first transistor, the second terminal of the third transistor coupled to a ground terminal, and the control terminal of the third transistor coupled to the output of the amplifier; a fourth transistor having first and second terminals and a control terminal, the first terminal of the fourth transistor and the control terminal of the fourth transistor coupled to the second terminal of the second transistor, and the second terminal of the fourth transistor coupled to the ground terminal; and a fifth transistor having first and second terminals and a control terminal, the first terminal of the fifth transistor coupled to the first input of the first comparator, the second terminal of the fifth transistor coupled to the ground terminal, and the control terminal of the fifth transistor coupled to the control terminal of the fourth transistor.

Example 27. The system of one of examples 20 to 26, where the first comparator receives signals at its first and second inputs only when the high-side transistor is turned on.

In this description, even if operations are described in a particular order, some operations may be optional, and the operations are not necessarily required to be performed in that particular order to achieve specified results. In some examples, multitasking and parallel processing may be advantageous. Moreover, a separation of various system components in some embodiments does not necessarily require such separation in all embodiments.

Modifications are possible in the described embodiments, and other embodiments are possible, within the scope of the claims.

What is claimed is:

1. An electronic circuit comprising:
an input voltage terminal;
an output voltage terminal;
an amplifier having an input and an output;
a switch having first and second terminals, the first terminal of the switch coupled to the output of the amplifier;
a voltage-to-current (V2I) circuit having an input and an output, the input of the V2I circuit coupled to the second terminal of the switch;
a first comparator having first and second inputs and an output, the first input of the first comparator coupled to the input voltage terminal, the second input of the first comparator coupled to a current sense terminal that is configurable to provide a voltage proportional to an inductor current;
a gate drive circuit having an input, and first and second outputs, the input of the gate drive circuit coupled to the output of the first comparator, the first and second outputs of the gate drive circuit configurable to provide control signals, respectively, to a high-side transistor and a low-side transistor;
a current sense circuit having an input and first and second outputs, the input of the current sense circuit coupled to the current sense terminal;
a current regulation circuit having an input and an output, the input of the current regulation circuit coupled to the first output of the current sense circuit, the output of the current regulation circuit coupled to the input of the V2I circuit;
a second comparator having an input and an output, the input of the second comparator coupled to the input of the amplifier;
a discharge circuit having an input and an output, the input of the discharge circuit coupled to the output of the second comparator, the output of the discharge circuit coupled to the output voltage terminal; and
a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the first input of the first comparator.

2. The electronic circuit of claim 1, wherein the discharge circuit includes:
a first transistor having first and second terminals and a control terminal, the control terminal of the first transistor coupled to the output of the second comparator, and the first terminal of the first transistor coupled to a voltage terminal;
a Zener diode coupled between the second terminal of the first transistor and the output voltage terminal;
a second transistor having first and second terminals and a control terminal, the first terminal of the second transistor coupled to the second terminal of the first transistor, the second terminal of the second transistor coupled to the output voltage terminal; and
a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

3. The electronic circuit of claim 1, further comprising a compensation circuit coupled to the current sense terminal.

4. The electronic circuit of claim 1, wherein the V2I circuit includes:
a first transistor having first and second terminals and a control terminal, the first terminal of the first transistor coupled to the input voltage terminal;
a second transistor having first and second terminals and a control terminal, the first terminal of the second transistor coupled to the input voltage terminal, and the control terminal of the second transistor coupled to the control terminal of the second transistor and the second terminal of the first transistor;
a third transistor having first and second terminals and a control terminal, the first terminal of the third transistor coupled to the second terminal of the first transistor, the second terminal of the third transistor coupled to a ground terminal, and the control terminal of the third transistor coupled to the output of the amplifier;
a fourth transistor having first and second terminals and a control terminal, the first terminal of the fourth transistor and the control terminal of the fourth transistor coupled to the second terminal of the second transistor, and the second terminal of the fourth transistor coupled to the ground terminal; and
a fifth transistor having first and second terminals and a control terminal, the first terminal of the fifth transistor coupled to the first input of the first comparator, the second terminal of the fifth transistor coupled to the ground terminal, and the control terminal of the fifth transistor coupled to the control terminal of the fourth transistor.

5. The electronic circuit of claim 1, wherein the first comparator is configurable to receive signals at its first and second inputs only when the high-side transistor is turned on.

6. The electronic circuit of claim 4, wherein the current sense circuit includes first and second filters, the first filter of the current sense circuit having a higher bandwidth than the second filter of the current sense circuit.

7. The electronic circuit of claim 1, further comprising:
a digital-to-analog converter (DAC) having an output;
a first resistor coupled between the output of the DAC and the input of the amplifier; and
a second resistor coupled between the input of the amplifier and the output voltage terminal.

8. The electronic circuit of claim 1, wherein the switch is a first switch, and the electronic circuit is further comprising a resistor and a second switch coupled in parallel between the output of the current regulation circuit and the input to the V2I circuit.

9. The electronic circuit of claim 8, wherein the resistor is a first resistor, the input to the amplifier is a first input to the amplifier, the amplifier has a second input, and the electronic circuit is further comprising a second resistor and a third switch coupled in parallel between the first and second inputs of the amplifier.

10. The electronic circuit of claim 1, wherein the input voltage terminal is configured to receive a positive voltage, and the output voltage terminal is configured to provide a negative voltage.

11. The electronic circuit of claim 1, further comprising an inductor coupled to the current sense terminal.

12. The electronic circuit of claim 1, wherein the inductor is a first inductor and the gate drive circuit is a first gate drive circuit, the electronic circuit further comprising a second inductor, a second gate drive circuit, and a phase transition circuit configurable to control phases and transitions from single-phase operation to two-phase operation.

13. The electronic circuit of claim 1, wherein the feedforward circuit includes:
a circuit configurable to provide a first current proportional to a voltage at the output voltage terminal;
a circuit configurable to provide a second current proportional to a voltage at the input voltage terminal;
a circuit configurable to provide a third current that is a sum of the first current and the second current; and
a circuit configurable to provide a fourth current that is a product of the third current and a current provided at the second output of the current sense circuit.

14. An electronic circuit comprising:
an input voltage terminal;
an output voltage terminal;
a first amplifier having an input and an output, the input of the first amplifier configurable to receive a command voltage;
a second amplifier having first and second inputs and an output, the first input of the second amplifier coupled to the output of the first amplifier, the second input of the second amplifier coupled to a ground terminal;
a first resistor and a first switch coupled in parallel between the first and second inputs of the second amplifier;
a second switch having first and second terminals, the first terminal of the second switch coupled to the output of the second amplifier;
a comparator having first and second inputs and an output, the first input of the comparator coupled to the first input of the second amplifier, the second input of the comparator coupled to a reference voltage source;
a third switch and a second resistor coupled in parallel between the second terminal of the second switch and the output of the comparator; and
a discharge circuit having an input and an output, the input of the discharge circuit coupled to the output of the comparator, the output of the discharge circuit coupled to the output voltage terminal.

15. The electronic circuit of claim 14, further comprising:
a third resistor having first and second terminals, the first terminal of the third resistor coupled to the output of the first amplifier; and
a fourth resistor having first and second terminals, the first terminal of the fourth resistor coupled to the second terminal of the first resistor, the second terminal of the fourth resistor coupled to an output voltage terminal.

16. The electronic circuit of claim 14, wherein the discharge circuit includes:
a first transistor having first and second terminals and a control terminal, the control terminal of the first transistor coupled to the output of the comparator, and the first terminal of the first transistor coupled to a voltage terminal;
a Zener diode coupled between the second terminal of the first transistor and the output voltage terminal;
a second transistor having first and second terminals and a control terminal, the first terminal of the second transistor coupled to the second terminal of the first transistor, the second terminal of the second transistor coupled to the output voltage terminal; and
a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

17. The electronic circuit of claim 14, wherein the second switch is configured to open in response to a change in the command voltage.

18. The electronic circuit of claim 17, wherein the third switch is configured to close in response to the second switch opening.

19. The electronic circuit of claim 14, further comprising a current regulation circuit having an input and an output, the input of the current regulation circuit coupled to a current sense circuit, the output of the current regulation circuit coupled to the output of the comparator.

20. A system, comprising:
an input voltage terminal;
an output voltage terminal;
a digital-to-analog converter (DAC) having an input and an output, the input of the DAC configurable to receive a command voltage;
an amplifier having an input and an output, the input of the amplifier coupled to the output of the DAC;
a switch having first and second terminals, the first terminal of the switch coupled to the output of the amplifier;
a voltage-to-current (V2I) circuit having an input and an output, the input of the V2I circuit coupled to the second terminal of the switch;
a first comparator having first and second inputs and an output, the first input of the first comparator coupled to an input voltage terminal, the second input of the first comparator coupled to a current sense terminal that is configurable to provide a voltage proportional to an inductor current;
a gate drive circuit having an input and first and second outputs, the input of the gate drive circuit coupled to the output of the first comparator, the first and second outputs of the gate drive circuit configurable to provide control signals, respectively, to a high-side transistor and a low-side transistor;
a current sense circuit having an input and first and second outputs, the input of the current sense circuit coupled to the current sense terminal;
a current regulation circuit having an input and an output, the input of the current regulation circuit coupled to the first output of the current sense circuit, the output of the current regulation circuit coupled to the input of the V2I circuit;
a second comparator having an input and an output, the input of the second comparator coupled to the input of the amplifier;
a discharge circuit having an input and an output, the input of the discharge circuit coupled to the output of the second comparator, the output of the discharge circuit coupled to an output voltage terminal; and
a feedforward circuit having first, second and third inputs and an output, the first input of the feedforward circuit coupled to the input voltage terminal, the second input of the feedforward circuit coupled to the output voltage terminal, the third input of the feedforward circuit coupled to the second output of the current sense circuit, and the output of the feedforward circuit coupled to the output of the V2I circuit.

21. The system of claim 20, wherein the switch is configured to open in response to a change in the command voltage.

22. The system of claim 21, wherein the switch is a first switch, and the system is further comprising a second switch and a resistor coupled in parallel between the second terminal of the first switch and the output of the first comparator.

23. The system of claim 22, wherein the second switch is configured to close in response to the first switch opening.

24. The system of claim 20, wherein a change in the command voltage changes a brightness of a display.

25. The system of claim 20, wherein the discharge circuit includes:
a first transistor having first and second terminals and a control terminal, the control terminal of the first transistor coupled to the output of the second comparator, and the first terminal of the first transistor coupled to a voltage terminal;
a Zener diode coupled between the second terminal of the first transistor and the output voltage terminal;
a second transistor having first and second terminals and a control terminal, the first terminal of the second transistor coupled to the second terminal of the first transistor, the second terminal of the second transistor coupled to the output voltage terminal; and
a third transistor having first and second terminals and a control terminal, the first terminal of the third transistor coupled to a ground terminal, the second terminal of the third transistor coupled to the output voltage terminal, and the control terminal of the third transistor coupled to the second terminal of the first transistor.

26. The system of claim 20, wherein the V2I circuit includes:
a first transistor having first and second terminals and a control terminal, the first terminal of the first transistor coupled to the input voltage terminal;
a second transistor having first and second terminals and a control terminal, the first terminal of the second transistor coupled to the input voltage terminal, and the control terminal of the second transistor coupled to the control terminal and the second terminal of the first transistor;
a third transistor having first and second terminals and a control terminal, the first terminal of the third transistor coupled to the second terminal of the first transistor, the second terminal of the third transistor coupled to a ground terminal, and the control terminal of the third transistor coupled to the output of the amplifier;
a fourth transistor having first and second terminals and a control terminal, the first terminal of the fourth transistor and the control terminal of the fourth transistor coupled to the second terminal of the second transistor, and the second terminal of the fourth transistor coupled to the ground terminal; and
a fifth transistor having first and second terminals and a control terminal, the first terminal of the fifth transistor coupled to the first input of the first comparator, the second terminal of the fifth transistor coupled to the ground terminal, and the control terminal of the fifth transistor coupled to the control terminal of the fourth transistor.

27. The system of claim 20, wherein the first comparator receives signals at its first and second inputs only when the high-side transistor is turned on.
